(19) United States
(12) Patent Application Publication
(10) Pub. No.: US 2007/0295451 A1
(43) Pub. Date: Dec. 27, 2007

(54) FOOTWEAR SOLE CONSTRUCTION

(75) Inventor: Charles C. Willis, North Somerset (GB)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: WOLVERINE WORLD WIDE,INC., Rockford, MI (US)

(21) Appl. No.: 11/425,764

(22) Filed: Jun. 22, 2006

(51) Int. Cl. C09J 5/00

(52) U.S. Cl. 156/306.6; 36/43

(57) ABSTRACT

A footwear adhesion system including a thermoplastic film, a sole component, and a footwear component. In one embodiment, the thermoplastic film is a thermoplastic polyurethane (“TPU”) film. The film is sandwiched between the sole component and the footwear component. The film may be activated, for example, by high frequency welding, to form a bond between the sole component and the footwear component without releasing the amount of volatile organic compound emissions typical with conventional adhesives. Use of the film reduces or eliminates the need for conventional environmentally unfriendly cement in footwear construction.

### BACKGROUND OF THE INVENTION

The present invention relates to footwear and, more particularly, to a footwear construction and method for making the same.

Cement is used in all kind of footwear constructions. Unfortunately, conventional cements are known to release volatile organic compound (“VOC”) emissions that are considered unfriendly to the environment. Further, rigorous safety precautions are often required to properly handle the cements. Despite these drawbacks, conventional cements are still prevalent because they provide the strength, quality, and aesthetic appeal desired by footwear manufacturers. For example, a cemented construction of an outside and upper provides a sufficient, and in some cases superior bond, without defacing the footwear with welts or stitches. Welts, stitching, or other adhesion techniques may be used in combination with cement to obtain the desired footwear appearance. As another example, various sole components may be cemented together (i.e. an outside, heel wedge, reinforcing plate, and midsole) to provide a sole assemble. Such a sole assemble may be difficult or even impossible to construct using non-adhesive techniques.

Cementing generally includes the steps of (a) preparing the surface of the shoe components for cementing using various techniques known in the art, such as scouring or roughing; (b) applying an even coating of cement to the surface of one or both components; (c) drying the cement to evaporate all of the solvent content; (d) heat activating the cement; and (e) pressing the components together.

Despite conventional cements sufficiently joining shoe components, the overall danger to the environment and necessity of safety precautions negatively affects the efficiency, cost, and overall desirability of cement in footwear constructions.

Accordingly, there remains a longfelt and unmet need for a footwear construction that provides only quality and strength, but also that is safe and efficient.

### SUMMARY OF THE INVENTION

The aforementioned problems are overcome by the present invention which provides a footwear adhesion system for joining a sole component with a footwear component using a thermoplastic film which replace or augments conventional cement in footwear constructions. In one embodiment, the thermoplastic film is thermoplastic polyurethane (“TPU”) film. In another embodiment, multiple sole components are joining to form a sole assembly. In another embodiment, an outside is joined with an upper using the footwear adhesion system of the present invention.

The footwear adhesion system of the present invention generally includes the steps of (a) providing a sole component and a footwear component; (b) positioning TPU film between the components; and (d) activating the film to join the components. Generally, fewer steps are necessary than in cemented footwear constructions because there is less preparation and wait time. For example, surfaces in cemented constructions may need to be roughed or scoured to ensure an even distribution of cement. TPU film on the other hand may be applied to surfaces without such preparation and is automatically suitably distributed due to its film nature. Surface preparation is permissible, if desired. Further, TPU film constructions are not held up waiting for solvent to evaporate as in cemented constructions.

The present invention results in several distinct advantages. First, because the invention eliminates the need for conventional cement, it greatly reduces the amount of VOC emissions released into the environment. Second, fewer safety precautions are necessary because the TPU film is substantially less dangerous for a user to handle. Third, use of TPU film results in increased efficiencies, such as less dry time, during the footwear construction process compared to cementing. Accordingly, a generally environmentally friendly footwear sole construction is provided.

These and other objects, advantages, and features of the invention will be more fully understood and appreciated by reference to the description of the current embodiment and the drawings.

### BRIEF DESCRIPTION OF THE DRAWINGS

FIG. 1 is an exploded view of a shoe constructed using the footwear adhesion system of the present invention.

FIG. 2 is a side view of the shoe constructed using the footwear adhesion system.

FIG. 3 is a side view of the shoe depicting the footwear adhesion system.

FIG. 4 is a cross sectional view of the toe of the shoe.

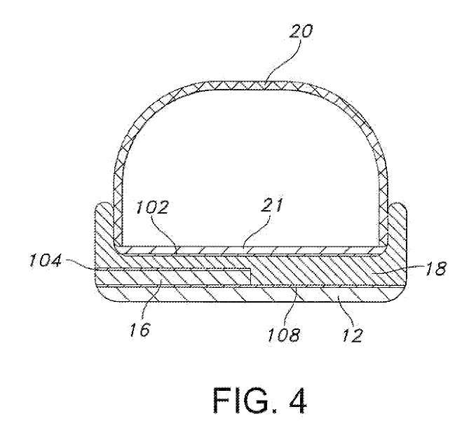

### DESCRIPTION OF THE CURRENT EMBODIMENT

### I. General Description

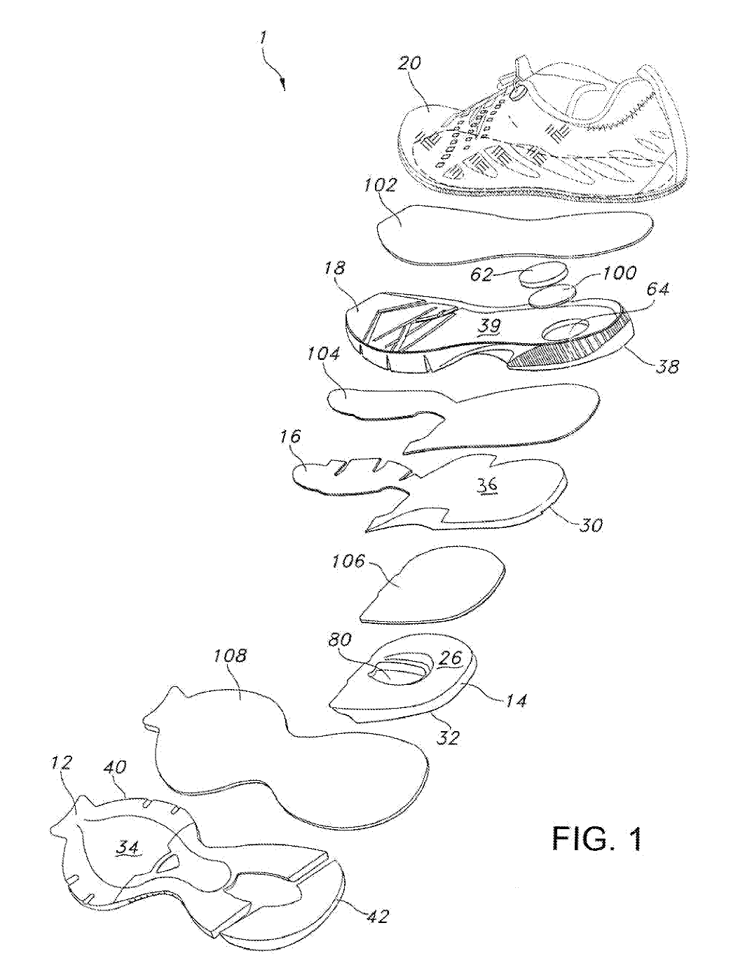

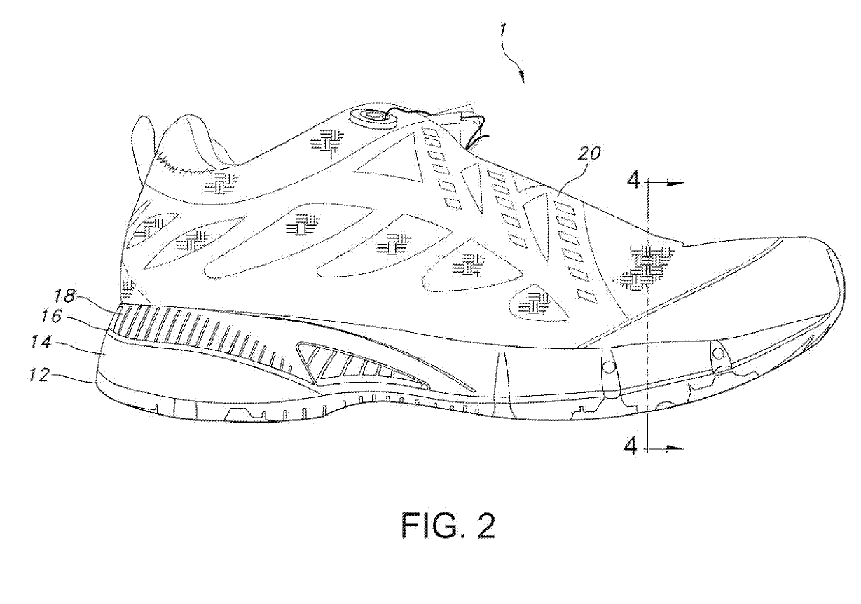

A shoe manufactured in accordance with an embodiment of the present invention is shown in FIGS. 1 and 2, and generally designated 1. The shoe 1 generally includes a footwear sole 10 and an upper 20. The footwear sole 10 generally includes an outsole 12, a heel wedge, 14, an insert 16, and a midsole 18. The footwear sole 10 may include additional, fewer, or different sole components, as desired. In the described embodiment, all of the sole components are joined with thermoplastic polyurethane (“TPU”) film to form the footwear sole 10. Moreover, the footwear sole 10 is joined with the upper 20 using TPU film to form an article of footwear, such as the shoe 1 shown in FIG. 2. The film is activated through the use of heat, high frequency welding, and pressure either alone or in combination. Excess film may be trimmed after the bonding process or the film may be precut to suitable dimensions. Although the present invention is described in connection with a conventional standard height running or trail running shoe 1, the present invention is not limited to use in shoes of that type. The present invention can be incorporated into essentially any type of footwear. Although the described embodiment uses thermoplastic film exclusively, various attachment constructions may supplement, including without limitation cement, stitch, welt and direct attach constructions.

### II. Detailed Description of TPU Film Construction Footwear

In the described embodiment, the outsole 12 is generally conventional and defines the primary wear surface for the sole 10. The outsole 12 is secured to the bottom of the sole 10 to provide a durable and non-slip wear surface (See FIG. 2). The design and configuration of the outsole 12 may vary from application-to-application. However, in the illustrated embodiment, the outsole 12 is a two-piece outsole having a main part 40 and heel part 42 (See FIG. 1). The main part 40 of this embodiment extends across portions of the heel wedge 14, insert 16 and midsole 18. The main part 40 is secured to the bottom of the various sole components 14, 16 and 18 using TPU film 108. The heel part 22 is disposed at the back of the heel and is attached to the undersurface of the heel wedge 14 using TPU film 108 as well. In an alternative embodiment, the TPU film 108 is split into two separate TPU films, one for the main part 40 and one for the heel part 42. The outsole 12 may be manufactured from a wide variety of conventional sole materials, such as natural and synthetic rubbers, leather, PVC, EVA and polyurethane.

As noted above, the sole 10 includes a heel wedge 14 disposed above the outsole 12 in the heel region (See FIGS. 1 and 2). The heel wedge 14 provides a resilient, compressible platform for the insert 16 as described in more detail below. The heel wedge 14 is generally wedge-shaped having an upper surface 26 that compliments the shape of the bottom surface 30 of the insert 16 and a lower surface 32 that compliments the shape of the upper surface 34 of the outsole 12. The upper surface 26 of the heel wedge 14 is secured to the bottom surface 30 of the insert 16 with TPU film 106. The lower surface 32 of the heel wedge 14 is secured to the outsole as described above using TPU film 108. The heel wedge 14 may be manufactured from a variety of sole material, such as EVA and polyurethane. In the illustrated embodiment, the heel wedge 14 defines a central opening 80 that is aligned with a corresponding absence of material in the heel region of the outsole 12. In an alternative embodiment, the opening 80 is deleted. In the illustrated embodiment, the heel wedge 14 extends only through the heel region of the sole 10 and is generally wedge-shaped. The heel wedge 14 may extend through different regions of the sole and may, for example, extend through the arch region be coextensive with the entire sole. The heel wedge 14 is not necessarily wedge-shaped and may take on different thickness configurations as desired. In the illustrated embodiment, the heel wedge 14 is manufactured from EVA foam having a durometer value of approximately 55-60 Asker C Scale. The type of material and density of the heel wedge 14 material may, however, vary from application to application. If desired, the, density of the heel wedge 14 may vary from region to region within the heel wedge 14. The heel wedge 14 is just one example of a sole component that may be attached using TPU film. Alternative embodiments may or may not include a heel wedge 14.

The insert 16 is disposed above the outsole 12 and the heel wedge 14, and provides the sole 10 with a support profile (See FIGS. 1 and 2). The upper surface 36 of the insert 16 is secured to the lower surface 38 of the midsole 18 using TPU film 104. The lower surface 30 of the insert 16 is secured to the upper surface 26 of the heel wedge 14 and the upper surface 34 of the outsole 12 as described above. The characteristics of the insert 16 may be varied to control the support characteristics of the sole 10. For example, changes in the width, thickness, and shape of the insert 16 will impact the support characteristics. The insert 16 may be manufactured from a variety of conventional materials, but typically it will be manufactured from a material that is stiffer than the heel wedge 14 and/or midsole 18. For example, the insert 16 may be injection molded from TPU, TPR or PVC. The insert 16 may be manufactured from other materials, such as nylon, rubber, synthetic rubber or silicone. As with the heel wedge, the insert 16 is optional and may be deleted as desired, depending on the specific footwear construction.

The midsole 18 is disposed between the insert 16 and the upper 20, and is designed to provide a compressible, resilient foot platform (See FIGS. 1 and 2). The upper surface 39 of the midsole 18 is secured to the bottom of the upper 20 using TPU film 108. The lower surface 38 of the midsole 18 is secured to the insert 16 and outsole 12 as described above. As it is designed to support the foot and to be incorporated into conventional footwear, the midsole 18 is generally foot-shaped. The midsole 18 may, however, take on other shapes, as desired, to accommodate various alternative sole designs. In the illustrated embodiment, the midsole 18 is manufactured from EVA foam having a durometer value of approximately 55-60 Asker C Scale. The type of material and density of the midsole 18 material may, however, vary from application to application. In the illustrated embodiment, the midsole 18 is a one-piece, unitary structure, but it may alternatively include a collection of separate elements that cooperatively support the foot. In most applications, an additional sole component (not shown) will be incorporated into the sole 10 above the midsole 18. For example, an insole (not shown), sock liner (not shown), footbed (not shown) or other sole element may be incorporated into the sole 10 above the midsole 18. This additional component may be removably fitted or permanently attached with TPU film atop the sole 10.

In the illustrated embodiment, the midsole 18 includes a disc-shaped plug 62 that is attached with TPU film in a corresponding recess 64 in the heel area (See FIG. 1). The plug 62 is manufactured from a relatively soft cushioning material, such as closed cell foam. In the illustrated embodiment, the plug 62 is manufactured from a material having a lower density than the material of the midsole 18. As a result, the plug 62 and recess 64 combination help to center the foot in the heel of the sole 10. The size, shape and configuration of the plug 62 and recess 64 may vary from application to application. The plug 62 and recess 64 combination are optional and may be eliminated.

The upper 20 is disposed above the midsole 18, and is designed to encase and protect the foot (See FIGS. 1 and 2). In the described embodiment, the upper 20 is shaped to cover and protect the foot when incorporated into conventional footwear. As described above, the upper surface of the midsole 18 is secured to the bottom of the upper 20 using TPU film 108. In the described embodiment, the bottom surface of the upper 20 is an insole board that has been stitched to the rest of the upper 20. The upper 20 may, however, take on other shapes, as desired, to accommodate various alternative footwear designs. In the illustrated embodiment, the upper 20 is manufactured from leather and the insole board 21 is manufactured from textiles. However, in other embodiments, the upper and insole board may be formed of synthetics or other suitable materials.

The above description identifies certain approximate durometer values for the various components of the sole 10 of the illustrated embodiment. The recited values are merely exemplary and the present invention is not limited to sole constructions with the specific recited durometer values. To the contrary, the present invention should be broadly interpreted to extend to sole components having different compressibility values.

As noted above, in the described embodiment, the TPU film is used to attach: 1) the outsole 16 to the heel wedge 14, insert 16, and midsole 18; 2) the heel wedge 14 to the insert 16; 3) the insert 16 to the midsole 18; 4) the plug 62 to the recess 64 of the midsole 18; and 5) the midsole 18 to the upper 20. The TPU film positions are merely exemplary and the present invention is not limited to constructions with the specific TPU film positions. To the contrary, the present invention should be broadly interpreted to extend to any sole component attached to any other footwear component, including another sole component, using TPU film or other thermoplastic films. One suitable TPU film, Sewfree®, may be obtained from, Bemis Associates Inc. Headquarters, located at One Bemis Way Shirley, Mass. 01464. Although the described embodiment illustrates a film, alternative embodiments may include other adhesives which minimize the amount of VOC emissions. For example, other thermoplastic films such as nylon, polyester, polyolefin, or vinyl films may replace or supplement the TPU film. In the described embodiment, the TPU films are precut to substantially match the surfaces to be joined. In alternative embodiments, the TPU film may be configured as desired depending on the application. For example, where minimizing the amount of TPU film is desired, the TPU film may be cut into strips, rings, or other suitable configurations. In the ring TPU film embodiment, the film is cut to follow the edge of the footwear component leaving the middle portion empty thereby reducing the amount of TPU film used in the construction. In the strip embodiment, the TPU film is cut in strips and applied in strategic locations. For example, in one embodiment, a selected amount of space is left between each strip to reduce the overall amount of TPU film used in the construction.

### III. Detailed Description of TPU Attachment Method

The method of constructing footwear using the TPU attachment method includes a) providing a sole component and a footwear component; b) positioning the TPU between the sole component and the footwear component; and c) activating the TPU to join the sole component and footwear component. Optionally, additional preparatory or finishing steps may be taken as desired. For example, the TPU film may be trimmed after the TPU is activated or be precut before being activated. Additionally, any suitable techniques known in the art to prepare the footwear may be applied. However, these techniques are optional as opposed to some cemented constructions where they are essentially required to form a suitable bond.

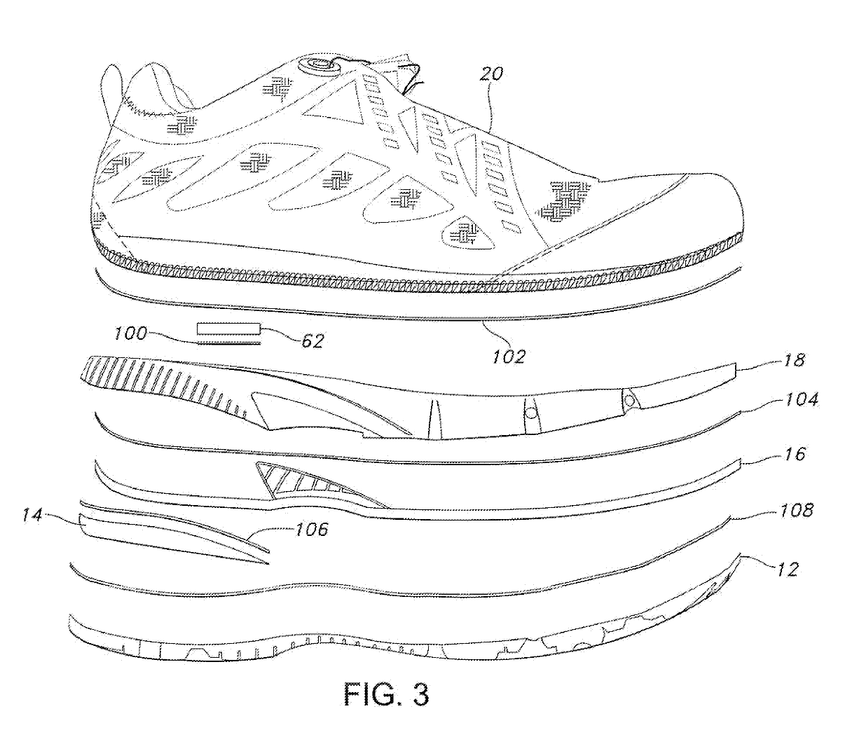

Referring now to FIG. 3, one method of applying multiple TPU attachments is supplied. First, the TPU film 100 is positioned inside the recess 64 between the plug 62 and recess 64 of the midsole 18. The TPU film 100 is activated to create a bond between the plug 62 and the midsole 18. Next, once the upper 20 is properly lasted, the TPU film 102 is positioned between the upper 20 and the midsole 18 and activated to form a corresponding bond. TPU film 104 is then positioned between the upper surface of the insert 16 and the lower surface of the midsole 18 and activated, thereby joining them. TPU film 106 is positioned between the heel wedge 14 and the insert 16 before being activated. Finally, TPU film 108 is positioned between the outsole 16 and the lower surface of the heel wedge 14, a portion of the lower surface of the insert 16, and a portion of the lower surface of the midsole 18 and then activate. In other embodiments, there may be additional or fewer footwear components joined together. In the described embodiment, at least one sole component is joined with at least one footwear component, which may also be a sole component. This method and order of attaching the footwear components is merely exemplary, the components may be attached in any suitable order.

The shoe components may be provided and positioned using techniques and equipment known in the art. For example, the TPU film may be tacked, laminated, or otherwise held in position between the shoe components.

The TPU film between the shoe components may be activated using techniques and equipment known in the art. For example, heat, high frequency welding or pressure either alone or in combination may be used to activate the TPU film.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A footwear adhesion system comprising:
a first sole component;
a footwear component; and
a thermoplastic film disposed between said first sole component and said footwear component, wherein said thermoplastic film joins said first sole component and said footwear component.

2. The footwear adhesion system as defined in claim 1 wherein said footwear component is an upper.

3. The footwear adhesion system as defined in claim 1 wherein said footwear component is a second sole component.

4. The footwear adhesion system as defined in claim 1 wherein said thermoplastic film is a thermoplastic polyurethane film that does not release substantial volatile organic compound emissions.

5. The footwear adhesion system as defined in claim 1 wherein said footwear adhesion system is substantially free of conventional cement.

6. The footwear adhesion system as defined in claim 1 wherein said thermoplastic film comprises one of polyurethane, nylon, polyester, polyolefin, vinyl, or any combination thereof.

7. A method of footwear construction comprising:
providing a first sole component and a footwear component;
positioning a thermoplastic film between the first sole component and the footwear component;
activating the thermoplastic film to form a bond between the first sole component and the footwear component, whereby said activating does not release a substantial amount of volatile organic compound emissions.

8. The method of footwear construction of claim 7 further comprising trimming the thermoplastic film to meet a desired specification.

9. The method of footwear construction of claim 7 wherein said footwear component is an upper.

10. The method of footwear construction of claim 7 wherein said footwear component is a second sole component.

11. The method of footwear construction of claim 7 wherein said footwear adhesion system is substantially free of conventional cement.

12. The method of footwear construction of claim 7 wherein said thermoplastic film comprises one of polyurethane, nylon, polyester, polyolefin, vinyl, or any combination thereof.

13. A method of footwear construction comprising:
providing a first sole component and a footwear component;
positioning a thermoplastic film between the first sole component and the footwear component;
activating the thermoplastic film to form a bond between the first sole component and the footwear component, whereby said bond is substantially free of conventional cement.

14. The method of footwear construction of claim 13 further comprising trimming the thermoplastic film to meet a desired specification.

15. The method of footwear construction of claim 13 further comprising cutting the thermoplastic film to size before said positioning.

16. The method of footwear construction of claim 13 wherein said footwear component is an upper.

17. The method of footwear construction of claim 13 wherein said footwear component is a second sole component.

18. The method of footwear construction of claim 13 whereby said activating does not release a substantial amount of volatile organic compound emissions.

19. The method of footwear construction of claim 13 wherein said thermoplastic film comprises one of polyurethane, nylon, polyester, polyolefin, vinyl, or any combination thereof.

20. The method of footwear construction of claim 13 wherein said fist sole component comprises a sole assembly.
